(19) United States
(12) Patent Application Publication
(10) Pub. No.: US 2025/0071624 A1
(43) Pub. Date: Feb. 27, 2025

(54) VOICE CALL SUPPORT IN WIRELESS COMMUNICATION SYSTEMS

(71) Applicant: Lenovo (Singapore) Pte. Ltd., New Tech Park (SG)

(72) Inventors: Prateek Basu Mallick, Dreieich (DE); Genadi Velev, Darmstadt (DE); Ravi Kuchibhotla, Chicago, IL (US); Hyung-Nam Choi, Ottobrunn (DE); Joachim Löhr, Wiesbaden (DE)

(21) Appl. No.: 18/726,762

(22) PCT Filed: Jan. 3, 2023
(86) PCT No.: PCT/IB2023/050034

§ 371 Date: Jul. 3, 2024

Related U.S. Application Data
(60) Provisional application No. 63/296,107, filed on Jan. 3, 2022.

(51) Int. Cl. H04W 36/00; H04L 65/1016; H04W 48/18

(52) U.S. Cl. CPC H04W 36/0022; H04L 65/1016; H04W 48/18

(57) ABSTRACT

Various aspects of the present disclosure relate to voice call support in wireless communication systems. An apparatus is configured to determine whether voice service is supported in a first cell of a wireless communication network. The apparatus is configured to, in response to determining the first cell does not support voice service, determine at least one second cell in neighboring EUTRA frequencies of the wireless communication network that supports voice service. The apparatus is configured to transmit a first indication of the at least one second cell that supports voice service to a UE.

### CROSS-REFERENCE TO RELATED APPLICATIONS

This application claims priority to U.S. Provisional Patent Application Ser. No. 63/296,107 entitled “VOICE CALL SUPPORT IN WIRELESS COMMUNICATION SYSTEM” and filed on Jan. 3, 2022, for Prateek Basu Mallick et al., which is incorporated herein by reference in its entirety.

### FIELD

The subject matter disclosed herein relates generally to wireless communications and more particularly relates to voice call support in wireless communication systems.

### BACKGROUND

In wireless communication systems, even though voice service support is standardized in 5G new radio (“NR”), its deployment is still lagging compared with available infrastructure support for data services. A driver for the development of 5G NR technology has been improved data services, including three verticals of enhanced mobile broadband (“eMBB”), ultra-reliable low latency communication (“URLLC”), and industrial internet of things (“IIoT”) requiring higher mobile data rates, increased reliability, and reduced latency. However, the legacy services of voice communications remain key for mobile services as end subscribers continue to use voice and video calls.

### BRIEF SUMMARY

Disclosed are procedures for voice call support in wireless communication system. Said procedures may be implemented by apparatus, systems, methods, and/or computer program products.

In one embodiment, a first apparatus includes a memory and a processor. In one embodiment, the processor is configured to cause the apparatus to determine whether voice service is supported in a first cell of a wireless communication network. In one embodiment, the processor is configured to cause the apparatus to, in response to determining the first cell does not support voice service, determine at least one second cell in neighboring EUTRA frequencies of the wireless communication network that supports voice service. In one embodiment, the processor is configured to cause the apparatus to transmit a first indication of the at least one second cell that supports voice service to a UE device.

In one embodiment, a first method determines whether voice service is supported in a first cell of a wireless communication network. In one embodiment, the first method, in response to determining the first cell does not support voice service, determines at least one second cell in neighboring EUTRA frequencies of the wireless communication network that supports voice service. In one embodiment, the first method transmits a first indication of the at least one second cell that supports voice service to a UE device.

In one embodiment, a second apparatus includes a memory and a processor. In one embodiment, the processor is configured to cause the apparatus to receive a first indication of whether voice service is supported in a first cell of a wireless communication network. In one embodiment, the processor is configured to cause the apparatus to, in response to the first indication indicating that the first cell does not support voice service, receive a second indication of at least one second cell in neighboring EUTRA frequencies of the wireless communication network that supports voice service. In one embodiment, the processor is configured to cause the apparatus to perform cell selection to one of the at least one second cell that supports voice service on a corresponding EUTRA frequency.

In one embodiment, a second method receives a first indication of whether voice service is supported in a first cell of a wireless communication network. In one embodiment, the second method, in response to the first indication indicating that the first cell does not support voice service, receives a second indication of at least one second cell in neighboring EUTRA frequencies of the wireless communication network that supports voice service. In one embodiment, the second method performs cell selection to one of the at least one second cell that supports voice service on a corresponding EUTRA frequency.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for voice call support in wireless communication systems;

FIG. 2 is a procedure flow diagram illustrating one embodiment of evolved packet system (“EPS”) fallback for IP Multimedia Subsystem (“IMS”) voice;

FIG. 3 depicts one example embodiment of paging message information element;

FIG. 4 depicts one example embodiment of a system information block (“SIB”) information element;

FIG. 5 depicts one example embodiment of CarrierFreqEUTRA information element;

FIG. 6 depicts one example embodiment of a procedure flow for voice call support in wireless communication system;

FIG. 7 depicts another example embodiment of paging message information element;

FIG. 8 depicts another example embodiment of paging message information element;

FIG. 9 depicts one embodiment of a procedure flow for establishing security for voice call support in wireless communication system;

FIG. 10 is a block diagram illustrating one embodiment of a user equipment apparatus that may be used for voice call support in wireless communication system;

FIG. 11 is a block diagram illustrating one embodiment of a network apparatus that may be used for voice call support in wireless communication system;

FIG. 12 is a flowchart diagram illustrating one embodiment of a method for voice call support in wireless communication system; and

FIG. 13 is a flowchart diagram illustrating one embodiment of another method for voice call support in wireless communication system.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for voice call support in wireless communication systems. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

More particularly, the subject matter disclosed herein relates to voice call support in wireless communication systems. 5G NR is a new radio access technology (“RAT”) developed by the third generation partnership project (“3GPP”) for the 5G mobile network. This disclosure concerns voice call support for user equipment (“UE”) being served in a 5G NR cell.

Even though voice service support is standardized in 5G new radio (“NR”), its deployment is still lagging compared with available infrastructure support for data services. A driver for the development of 5G NR technology has been improved data services, including three verticals of eMBB, URLLC, and IIoT requiring higher mobile data rates, increased reliability, and reduced latency. However, the legacy services of voice communications remain key for mobile services as end subscribers continue to use voice and video calls.

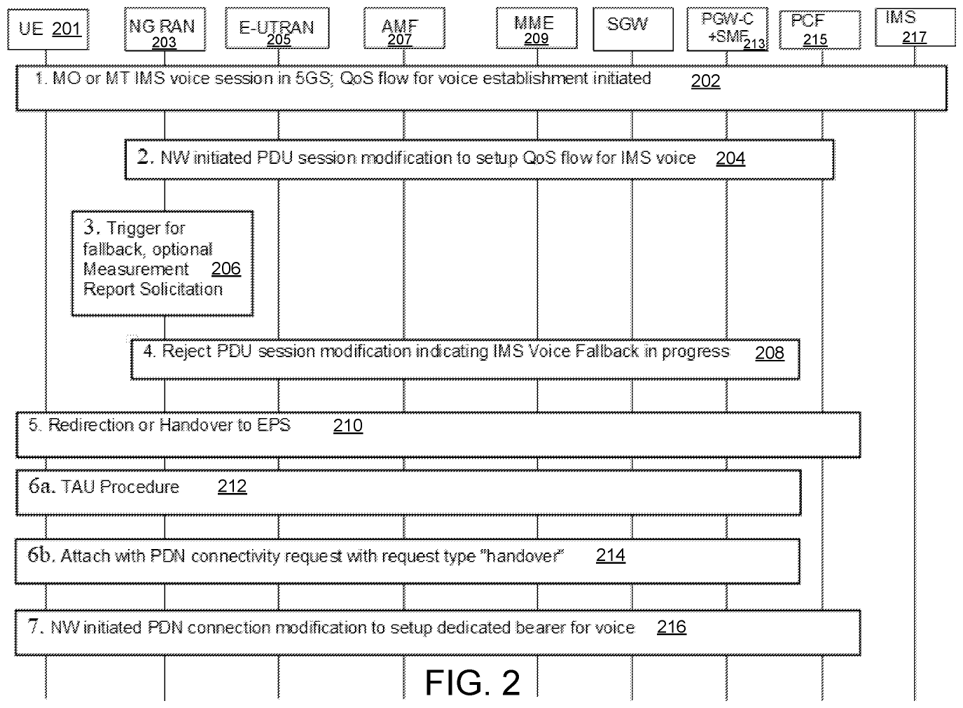

Voice service is not uniformly supported across 5G networks and to support voice calls, EPS fallback is used (see FIG. 2 below). A conventional solution to enable Mobile Terminating (“MT”) support for voice calls is proposed below:
Proposal 1: To reduce the EPS fallback latency for the case that UE is paged in RRC_IDLE for voice service, RAN2 to agree the following enhancements:
   a. When the paging message indicates voice service, the UE sets the NR radio resource control (“RRC”) establishment cause as voice instead of mt-access.
   b. The gNB can include EPS fallback indication in paging message, the UE selects an E-UTRA cell to establish the RRC connection and sets the E-UTRA RRC establishment cause as voice.
   c. The gNB can indicate the E-UTRA frequencies in SIB to assist the UE to select an E-UTRA cell for voice service.
Proposal 2: To reduce the EPS fallback latency for the case that UE is paged in RRC_INACTIVE for voice service, RAN2 to agree the following enhancements:
   a. When the RAN paging message indicates voice service, the UE sets the NR RRC resume cause as voice instead of mt-access.
   b. The gNB can include EPS fallback indication in RAN paging message, the UE selects an E-UTRA cell to establish the RRC connection and sets the E-UTRA RRC establishment cause as voice.
   c. The gNB can indicate the E-UTRA frequencies in SIB to assist the UE to select an E-UTRA cell for voice service.

However, the above solution has some shortcomings:
First, it is unnecessary to blindly “move” to evolved universal terrestrial radio access (“EUTRA”) if the serving NR cell supports the voice call, voice over new radio (“VoNR”)—the VoNR support is not broadcasted according to 3GPP TS38.331-g60, incorporated herein by reference. A 5G NR cell may only indicate IMS support for emergency calls (ims-EmergencySupport and ims-EmergencySupport5GC), but this is only for UEs camping in a limited service state.
Second, in some cases, even a target EUTRA cell may not support VOLTE and may require the UE to perform Circuit Switched Fallback (“CSFB”) (defined in 3GPP TS 23.221, incorporated herein by reference) instead. This will further delay the voice service establishment and affect user experience.
Third, concerns have been expressed in use of a Paging message. Even though a new Paging cause for mobile terminating (“MT”) voice call has already been agreed to be introduced in 5G NR, if this would also serve as a basis for UE to reselect another frequency/RAT, this could potentially lead to a Denial of Service (“DoS”) attack.
Finally, the problem and the solution described above is only applicable for mobile terminating calls and not for mobile originating calls.

The subject matter herein describes means to send and receive a target frequency information where voice service is supported, minimizing delays, avoiding unnecessary reselections to EUTRA, and using secured paging message. Further, the proposed solutions avoid unnecessary/blind reselection to EUTRA frequency. In one embodiment, the proposed solution first checks if the serving NR cell supports voice service and triggers reselection to EUTRA only when necessary and on EUTRA frequencies that support voice service. The proposed solutions apply to mobile originating (“MO”) calls in addition to MT calls. Also, the proposed solutions disclosed herein secure Paging messages to minimize the possibility of DoS attacks when, as a result of receiving voice Paging, the UE would be tempted to immediately reselect a EUTRA frequency.

In one embodiment, a 5G cell will indicate to an RRC_Idle UE if it supports VoNR. This can be done using broadcast signaling e.g., including one bit explicitly indicating this in SIB1 or any other SIB e.g., SIB2 or SIB5. Alternatively, this information can also be included in a Paging message by a gNB if there's at least one UE being paged for Voice call. On the other hand, if 5G cell does not support VoNR, it will indicate if all EUTRA neighbors (cells on any neighboring frequency listed in SIB5) support voice service or only some specific EUTRA frequencies.

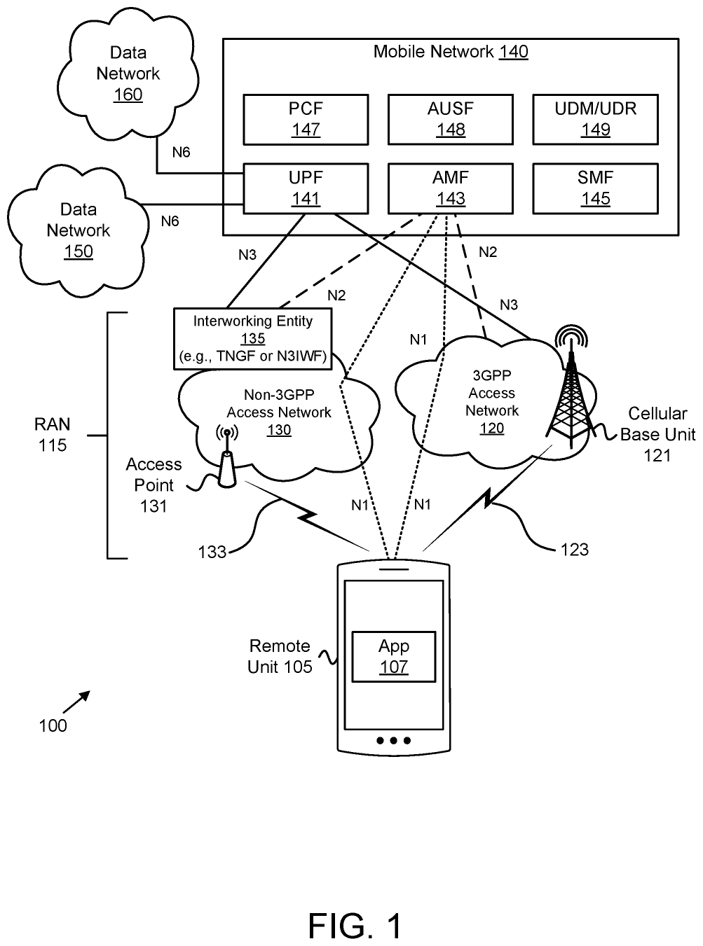

FIG. 1 depicts a wireless communication system 100 for voice call support in wireless communication systems, according to embodiments of the disclosure. In one embodiment, the wireless communication system 100 includes at least one remote unit 105, a 5G-RAN 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the 3GPP specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote units 105 include a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote units 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The relay units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the relay units 105 may communicate with one or more access points 131 in the non-3GPP access network(s) 130 via UL and DL communication signals carried over the non-3GPP communication links 133. Here, the access networks 120 and 130 are intermediate networks that provide the relay units 105 with access to the mobile core network 140.

In some embodiments, the relay units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the EPS, a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a RAN, such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

As background, 5G NR is a new radio access technology developed by 3GPP for the 5G mobile network. This disclosure document concerns voice call support for UEs being served in a 5G NR cell.

Voice service over 5G NR is supported as voice over new radio (“VoNR”), providing voice service using IMS (IMS support for 5GC is defined in 3GPP TS 23.228, which is incorporated herein by reference). The 5G System architecture supports an N5 interface between PCF and proxy-call session control function (“P-CSCF”) and supports reception interface between PCF and P-CSCF, to enable IMS service. However, at the current state of deployment, IMS support is not available uniformly across 5G networks and in such cases the EPS Fallback for IMS voice can be used (EPS Fallback is defined in 3GPP TS 23.502, which is incorporated herein by reference). The EPS Fallback procedure for IMS voice is shown in FIG. 2 and described below.

When the UE 201 is served by the 5G System, the UE 201 has one or more ongoing PDU Sessions each including one or more QoS Flows. The serving PLMN AMF 207 has sent an indication towards the UE 201 during the Registration procedure that IMS voice over PS session is supported, see clause 5.16.3.10 in TS 23.501 (incorporated herein by reference) and the UE 201 has registered in the IMS 217. If N26 is not supported, the serving PLMN AMF 207 sends an indication towards the UE 201 during the Registration procedure that interworking without N26 is supported, see clause 5.17.2.3.1 in TS 23.501.

At step 1 (see block 202), the UE 201 camps on NG-RAN 203 in the 5GS and an MO or MT IMS voice session establishment is initiated.

At step 2 (see block 204), a network initiated PDU Session modification to setup QoS flow for voice reaches the NG-RAN 203 (see N2 PDU Session Request in clause 4.3.3).

At step 3 (see block 206), the NG-RAN 203 is configured to support EPS fallback for IMS voice and decides to trigger fallback to EPS, taking into account UE capabilities, indication from AMF 207 that “Redirection for EPS fallback for voice is possible” (received as part of initial context setup, handover resource allocation or path switch request acknowledge as defined in TS 38.413, incorporated herein by reference), network configuration (e.g., N26 availability configuration) and radio conditions. If NG-RAN decides not to trigger fallback to EPS, then the procedure stops here, and the subsequent steps are not executed. The NG-RAN 203 may initiate measurement report solicitation from the UE 201 including E-UTRAN as target.

It is noted that if AMF 207 has indicated that “Redirection for EPS fallback for voice is not possible”, then EPS fallback for IMS voice is not performed in step 5. If NG-RAN 203 has not received indication “Redirection for EPS fallback for voice”, the decision to execute EPS fallback for IMS voice or not is based on network configuration (e.g., based on N26 availability and other criteria).

At step 4 (see block 208), NG-RAN 203 responds indicating rejection of the PDU Session modification to setup QoS flow for IMS voice received in step 2 by PDU Session Modification Response message towards the SMF+PGW-C 213 (or H-SMF+P-GW-C via V-SMF, in the case of home routed roaming scenario) via AMF 207 with an indication that mobility due to fallback for IMS voice is ongoing. The SMF+PGW-C 213 maintains the PCC rule(s) associated with the QoS Flow(s) and reports the EPS Fallback event to the PCF 215 if PCF 215 has subscribed to this event.

At step 5, (see block 210), the NG-RAN 203 initiates either handover (see clause 4.11.1.2.1), or AN Release via inter-system redirection to EPS (see clause 4.2.6 and clause 4.11.1.3.2), taking into account UE capabilities. The SMF+PGW-C 213 reports change of the RAT type if subscribed by PCF 215 as specified in clause 4.11.1.2.1, or clause 4.11.1.3.2.6. When the UE is connected to EPS, either steps 6a or 6b is executed.

At step 6a (see block 212), in the case of 5GS to EPS handover, see clause 4.11.1.2.1, and in the case of inter-system redirection to EPS with N26 interface, see clause 4.11.1.3.2. In either case the UE initiates TAU procedure and the UE includes active flag in the request in the case of inter-system redirection to EPS; or

At step 6b (see block 214), in the case of inter-system redirection to EPS without N26 interface, see clause 4.11.2.2. If the UE 201 supports Request Type flag “handover” for PDN connectivity request during the attach procedure, as described in clause 5.3.2.1 of TS 23.401 (incorporated herein by reference) and has received the indication that interworking without N26 is supported, then the UE initiates Attach with PDN connectivity request with request type “handover”.

In the case of inter-system redirection for the emergency service, the UE 201 uses the emergency indication in the RRC message as specified in clause 6.2.2 of TS 36.331 (incorporated herein by reference) and E-UTRAN 205 provides the emergency indication to MME 209 during Tracking Area Update or Attach procedure. For the handover procedure see clause 4.11.1.2.1, step 1.

At step 7 (see block 216), after completion of the mobility procedure to EPS or as part of the 5GS to EPS handover procedure, the SMF+PGW-C 213 re-initiates the setup of the dedicated bearer(s) for the maintained PCC rule(s) in step 4 including of the dedicated bearer for IMS voice, mapping the 5G QoS to EPC QoS parameters as specified in clause 4.11.1.2.1. The SMF+PGW-C 213 reports about Successful Resource Allocation and Access Network Information if subscribed by PCF 215.

The IMS signaling related to IMS voice call establishment continues after step 1 as specified in the TS 23.228 (incorporated herein by reference). At least for the duration of the voice call in EPS the E-UTRAN is configured to not trigger any handover to 5GS.

The above procedure “EPS Fallback” is defined in the 3GPP specification only for an RRC_Connected UE. For RRC_Idle and RRC_Inactive UEs, after receiving MT paging it must first get RRC Connected on the serving NR cell and then the network can apply the current EPS Fallback solution. This inherently delays UE's response time for a voice MT call by some hundreds of milliseconds as the UE must first perform RACH procedure, establish security in NR, be configured for and perform measurements of target frequency/RAT, perform cell selection/handover on the target frequency/RAT, get RRC Connected, initiate Service request and so on. This affects user experience.

In one embodiment, this disclosure describes means to improve voice service support for a UE currently being served by a 5G NR cell by minimizing latency to find a target frequency/RAT supporting voice supporting and by making a paging message indicating voice MT call secure. Though “voice service” is the main service throughout this disclosure, the disclosure can equally apply to any other service.

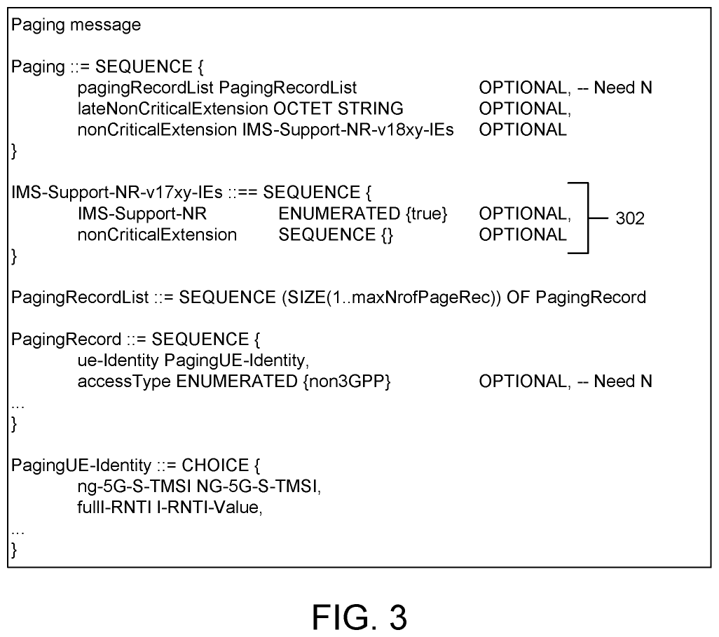

In a first embodiment, a 5G cell will indicate to an RRC_Idle UE if it supports VoNR. This can be done using broadcast signaling e.g., including one bit explicitly indicating this in SIB1 or any other SIB e.g., SIB2 or SIB5. Alternatively, this information can also be included in a Paging message by a gNB if there's at least one UE being paged for Voice call. One example of a Paging message that includes an indication 302 of VoNR support is shown in FIG. 3.

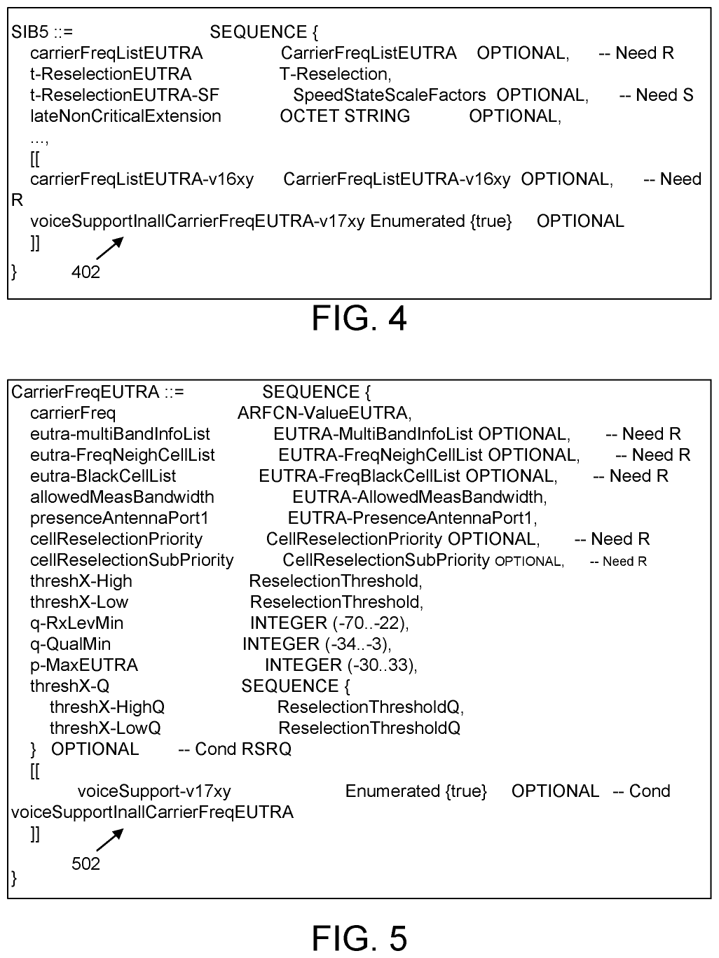

On the other hand, in one embodiment, if a 5G cell does not support VoNR it will indicate if all EUTRA neighbors (cells on any neighboring frequency listed in SIB5) support voice service. In the current RRC specification, SIB5 contains information relevant only for inter-RAT cell re-selection e.g., information about E-UTRA frequencies and E-UTRA neighboring cells relevant for cell re-selection. The new indication can be included e.g., at the top level inside SIB5; like including information element (“IE”) voiceSupportInallCarrierFreqEUTRA 402 as shown in FIG. 4.

In one embodiment, if the voiceSupportInallCarrierFreqEUTRA 402 IE is absent (e.g., it is an OPTIONAL IE), the UE assumes that the serving NR cell/frequency supports voice service.

If voiceSupportInallCarrierFreqEUTRA-v17xy 402 is set to false e.g., not all EUTRA neighbors support voice service, then the network indicates per listed frequency (in CarrierFreqListEUTRA-v16xy) if it supports voice service. As an example, this can be done by including voice Support 502 for each frequency (present when conditionally voiceSupportInallCarrierFreqEUTRA 402 is set to ‘false’) in the frequency list, as shown in FIG. 5.

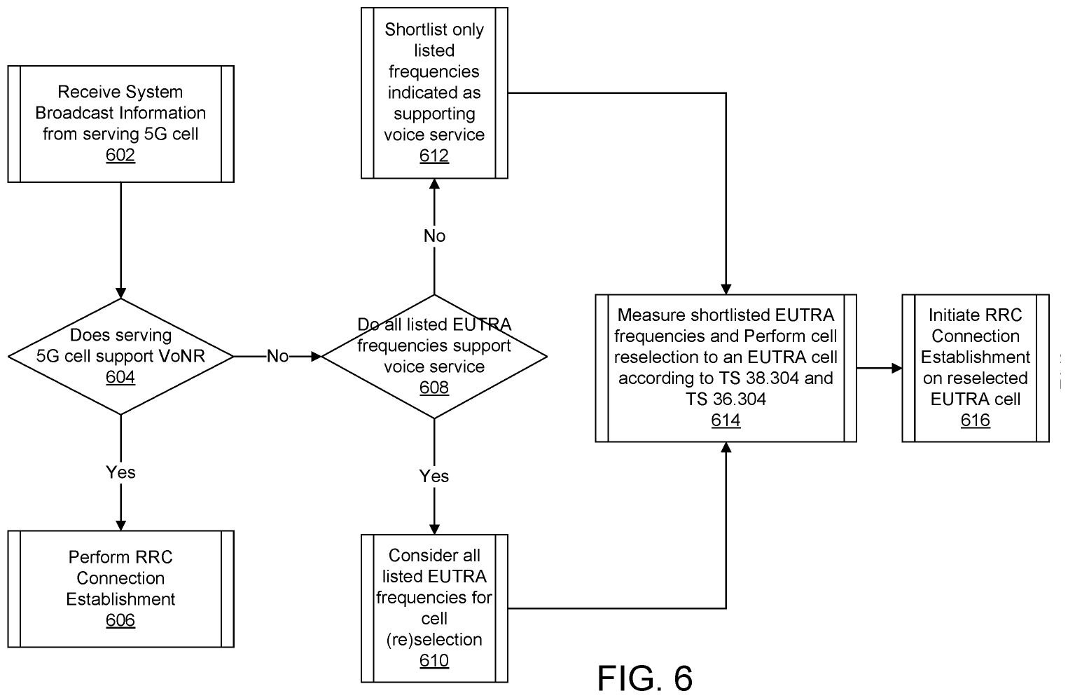

As shown in FIG. 6, a UE, in one embodiment, will receive 602 the above information from the network. If the VoNR is indicated 604 as supported in the serving cell, in one embodiment, the UE will initiate 606 RRC Connection establishment on the serving cell. Otherwise, if voiceSupportInallCarrierFreqEUTRA is set to True, in one embodiment, UE will initiate 608, 610 measurement on any EUTRA frequency listed in SIB5. However, if voiceSupportInallCarrierFreqEUTRA is set to False, in one embodiment, UE will specifically look 612 for one or more EUTRA (LTE) frequencies for which voiceSupport is set to True. Thereafter, in one embodiment, it will perform cell (re)selection procedure 614 on the shortlisted EUTRA frequencies and reselect a cell meeting all cell reselection criteria, in accordance with 3GPP TS36.304 (incorporated herein by reference) to initiate 616 RRC Connection Establishment on the reselected EUTRA cell. If no frequency is shortlisted, in one embodiment, since none of the EUTRA frequencies support voice service, and a CS Fallback indication with corresponding information (e.g., RAT and frequency) is included, UE starts with CSFB based on this information.

The methods described from this embodiment, in one embodiment, are applicable to an RRC_Idle as well as to an RRC_Inactive UE. For the latter, as a variation of this embodiment, the voice support indication can be delivered in RRCRelease message or in a RRC message sent by the network to the UE as a response to RRCResumeRequest and RRCResumeRequest1 sent by the UE, when it initiates connection resumption after having received the Paging message (for voice MT call) or when it wants to initiate a voice call.

The methods described from this embodiment, in one embodiment, are applicable equally to mobile terminating voice calls as well as to mobile originating voice calls. In the latter case voice support related information is received in broadcast messages and/or in dedicated RRC signaling.

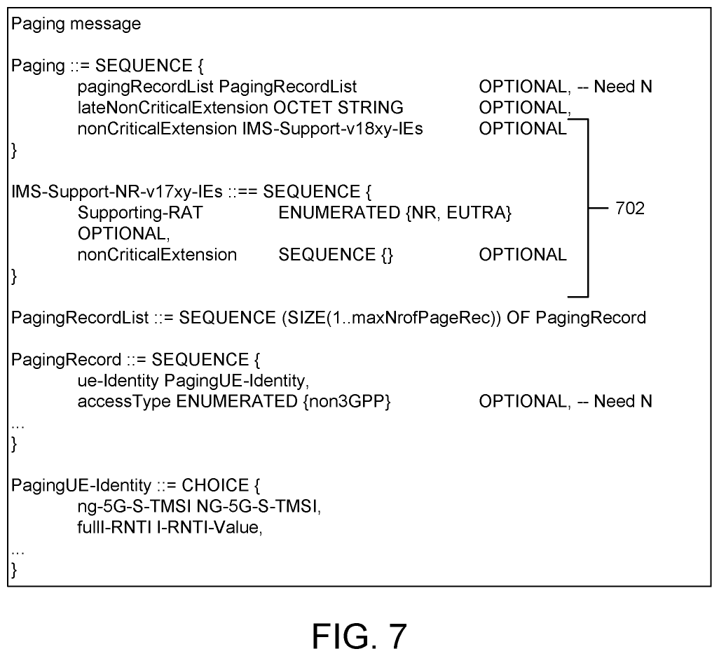

In a second embodiment, the voice support information of a EUTRA cell/frequency is sent to the UE in a Paging message. In such an embodiment, a frequency supporting a voice service and/or a network slice can be indicated in a paging message in a new IE called “SliceCheckInfo”. As a possible simplification, the voice support on one or more frequencies/RAT can be indicated 702 in Paging message as shown in FIG. 7.

In the above example, when Supporting-RAT is set to NR, the UE can initiate RRC Connection establishment in NR. When it is set to EUTRA, in one embodiment, the UE can initiate measurements on EUTRA frequencies that it may already have stored from SIB5 or it may first begin to acquire SIB5. Thereafter, it reselects a EUTRA cell and initiates RRC Connection establishment, as previously mentioned.

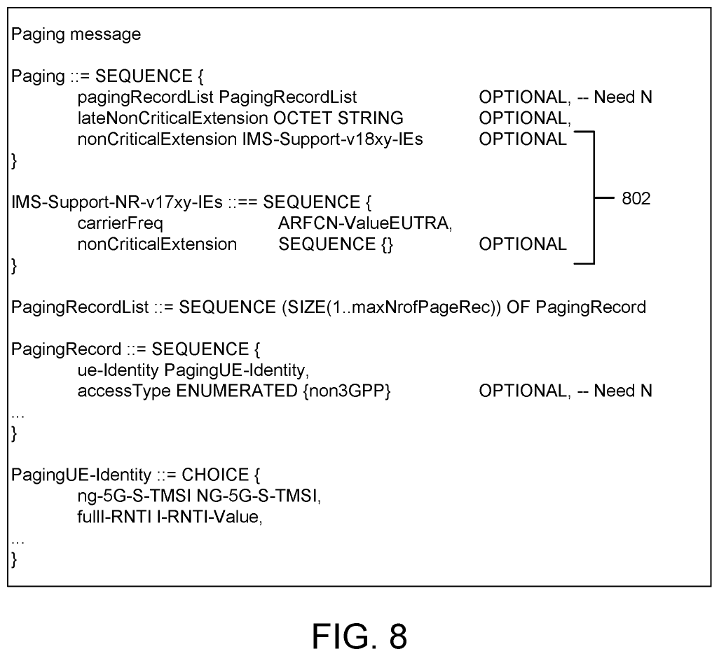

In FIG. 8, the network includes one EUTRA frequency 802 (more can be included) if the serving NR cell does not support voice service.

In a third embodiment, solutions are described that enhance the paging message security. If the Paging message contains a paging cause indicating MT voice call, a UE might reselect to a EUTRA frequency/cell, as revealed in the previous embodiments. This could lead to a DoS attack if the Paging message is sent from an attacker. The attack may be severe if a target frequency (e.g., an EUTRA frequency) has been included in the paging message.

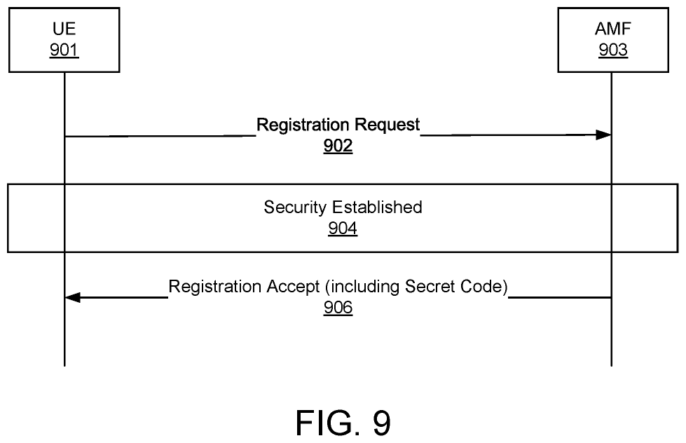

To overcome such an attack, as shown in FIG. 9, a UE 901 can receive a secret code from a network (e.g., AMF 903) (see messaging 906) during registration/re-registration procedure (see messaging 902), once NAS/AS security has been established (see block 904). This code, in one embodiment, is included by the network when paging the UE 901 for voice call or when including a target frequency or in general when paging the UE 901. This code may be included as part of UE's PagingRecord and upon receiving the secret code, the UE 901 knows that the paging is received from a genuine source. The secret code can be refreshed from time to time e.g., when performing periodic registration. Alternatively, a new secret code can be attained using a registration procedure when the current one has been used already. As an enhancement, a UE 901 can be provided more than one secret codes, and when all the codes are used, the UE 901 performs the registration procedure again.

In a fourth embodiment, the UE, after concluding the voice service in the target frequency, comes back to the source RAT. Given the example so far in this disclosure, the UE will reselect back to NR once the voice call has been terminated or even if it could not be started or ended abruptly in the “middle of the call,” after the EPS fallback to an LTE frequency is done.

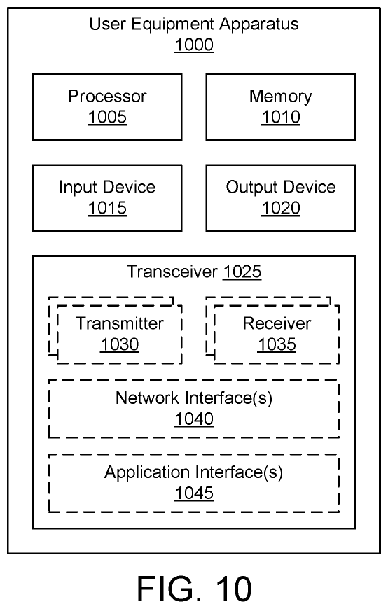

FIG. 10 depicts a user equipment apparatus 1000 that may be used for voice call support in wireless communication systems, according to embodiments of the disclosure. In various embodiments, the user equipment apparatus 1000 is used to implement one or more of the solutions described above. The user equipment apparatus 1000 may be one embodiment of the remote unit 105, described above. Furthermore, the user equipment apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the user equipment apparatus 1000 may not include any input device 1015 and/or output device 1020. In various embodiments, the user equipment apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. In some embodiments, the transceiver 1025 communicates with one or more cells (or wireless coverage areas) supported by one or more base units 121. In various embodiments, the transceiver 1025 is operable on unlicensed spectrum. Moreover, the transceiver 1025 may include multiple UE panel supporting one or more beams. Additionally, the transceiver 1025 may support at least one network interface 1040 and/or application interface 1045. The application interface(s) 1045 may support one or more APIs. The network interface(s) 1040 may support 3GPP reference points, such as Uu, N1, PC5, etc. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025. In certain embodiments, the processor 1005 may include an application processor (also known as “main processor”) which manages application-domain and operating system (“OS”) functions and a baseband processor (also known as “baseband radio processor”) which manages radio functions.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to voice call support in wireless communication system. For example, the memory 1010 may store various parameters, panel/beam configurations, resource assignments, policies, and the like as described above. In certain embodiments, the memory 1010 also stores program code and related data, such as an operating system or other controller algorithms operating on the user equipment apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the user equipment apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all, or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 communicates with one or more network functions of a mobile communication network via one or more access networks. The transceiver 1025 operates under the control of the processor 1005 to transmit messages, data, and other signals and also to receive messages, data, and other signals. For example, the processor 1005 may selectively activate the transceiver 1025 (or portions thereof) at particular times in order to send and receive messages.

The transceiver 1025 includes at least transmitter 1030 and at least one receiver 1035. One or more transmitters 1030 may be used to provide UL communication signals to a base unit 121, such as the UL transmissions described herein. Similarly, one or more receivers 1035 may be used to receive DL communication signals from the base unit 121, as described herein. Although only one transmitter 1030 and one receiver 1035 are illustrated, the user equipment apparatus 1000 may have any suitable number of transmitters 1030 and receivers 1035. Further, the transmitter(s) 1030 and the receiver(s) 1035 may be any suitable type of transmitters and receivers. In one embodiment, the transceiver 1025 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1025, transmitters 1030, and receivers 1035 may be implemented as physically separate components that access a shared hardware resource and/or software resource, such as for example, the network interface 1040.

In various embodiments, one or more transmitters 1030 and/or one or more receivers 1035 may be implemented and/or integrated into a single hardware component, such as a multi-transceiver chip, a system-on-a-chip, an ASIC, or other type of hardware component. In certain embodiments, one or more transmitters 1030 and/or one or more receivers 1035 may be implemented and/or integrated into a multi-chip module. In some embodiments, other components such as the network interface 1040 or other hardware components/circuits may be integrated with any number of transmitters 1030 and/or receivers 1035 into a single chip. In such embodiment, the transmitters 1030 and receivers 1035 may be logically configured as a transceiver 1025 that uses one more common control signals or as modular transmitters 1030 and receivers 1035 implemented in the same hardware chip or in a multi-chip module.

In one embodiment, the processor 1005 is configured to cause the apparatus 1000 to receive a first indication of whether voice service is supported in a first cell of a wireless communication network. In one embodiment, the processor 1005 is configured to cause the apparatus 1000 to, in response to the first indication indicating that the first cell does not support voice service, receive a second indication of at least one second cell in neighboring EUTRA frequencies of the wireless communication network that supports voice service. In one embodiment, the processor 1005 is configured to cause the apparatus 1000 to perform cell selection to one of the at least one second cell that supports voice service on a corresponding EUTRA frequency.

In one embodiment, in response to the first indication indicating that the first cell supports voice service, the processor 1005 is configured to cause the apparatus 1000 to initiate RRC connection establishment on the first cell.

In one embodiment, in response to the second indication indicating that all second cells in neighboring EUTRA frequencies support voice service, the processor 1005 is configured to cause the apparatus 1000 to perform cell selection for the UE on any neighboring EUTRA frequency provided in a system information block.

In one embodiment, in response to the second indication indicating that a subset of all second cells in neighboring EUTRA frequencies support voice service, the processor 1005 is configured to cause the apparatus 1000 to perform cell selection for the UE on at least one of the subset of neighboring EUTRA frequencies provided in a system information block, the subset listed by EUTRA frequency in the system information block.

In one embodiment, in response to the second indication indicating that none of the second cells in neighboring EUTRA frequencies support voice service, the processor 1005 is configured to cause the apparatus 1000 to perform circuit switched fallback.

In one embodiment, the processor 1005 is configured to cause the apparatus 1000 to receive the first or second indications using broadcast signaling, a paging message, or a combination thereof.

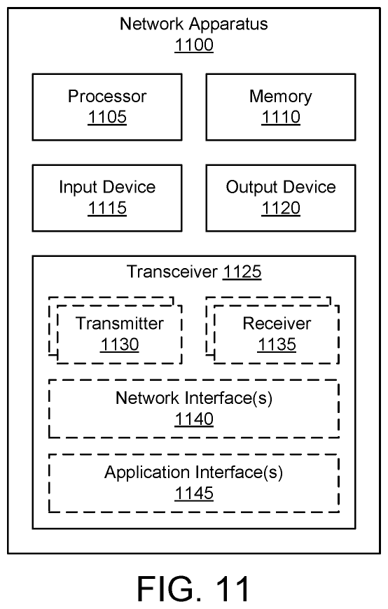

FIG. 11 depicts a network apparatus 1100 that may be used for voice call support in wireless communication system, according to embodiments of the disclosure. In one embodiment, network apparatus 1100 may be one implementation of a RAN node, such as the base unit 121, the RAN node 210, or gNB, described above. Furthermore, the base network apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the network apparatus 1100 may not include any input device 1115 and/or output device 1120. In various embodiments, the network apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more remote units 105. Additionally, the transceiver 1125 may support at least one network interface 1140 and/or application interface 1145. The application interface(s) 1145 may support one or more APIs. The network interface(s) 1140 may support 3GPP reference points, such as Uu, N1, N2 and N3. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a CPU, a GPU, an auxiliary processing unit, a FPGA, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125. In certain embodiments, the processor 805 may include an application processor (also known as “main processor”) which manages application-domain and OS functions and a baseband processor (also known as “baseband radio processor”) which manages radio function.

In various embodiments, the network apparatus 1100 is a RAN node (e.g., gNB) that provides on-demand SIBs. In one embodiment, the network apparatus 1100 includes a transceiver 1125 that receives, at a mobile wireless communication network from a first UE device, a request for an on-demand SIB for a second UE device, the first UE device comprising a relay UE device and the second UE device comprising a remote UE device and broadcasts the on-demand SIB to the first UE device for a predetermined period of time.

The memory 1110, in one embodiment, is a computer readable storage medium. In some embodiments, the memory 1110 includes volatile computer storage media. For example, the memory 1110 may include a RAM, including DRAM, SDRAM, and/or SRAM. In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to voice call support in wireless communication system. For example, the memory 1110 may store parameters, configurations, resource assignments, policies, and the like, as described above. In certain embodiments, the memory 1110 also stores program code and related data, such as an operating system or other controller algorithms operating on the network apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the network apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all, or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. One or more transmitters 1130 may be used to communicate with the UE, as described herein. Similarly, one or more receivers 1135 may be used to communicate with network functions in the NPN, PLMN and/or RAN, as described herein. Although only one transmitter 1130 and one receiver 1135 are illustrated, the network apparatus 1100 may have any suitable number of transmitters 1130 and receivers 1135. Further, the transmitter(s) 1130 and the receiver(s) 1135 may be any suitable type of transmitters and receivers.

In one embodiment, the processor 1105 is configured to cause the apparatus 1100 to determine whether voice service is supported in a first cell of a wireless communication network. In one embodiment, the processor 1105 is configured to cause the apparatus 1100 to, in response to determining the first cell does not support voice service, determine at least one second cell in neighboring EUTRA frequencies of the wireless communication network that supports voice service. In one embodiment, the processor 1105 is configured to cause the apparatus 1100 to transmit a first indication of the at least one second cell that supports voice service to a UE device.

In one embodiment, the processor 1105 is configured to cause the apparatus 1100 to, in response to determining the first cell supports voice service, transmit a second indication that the first cell supports voice service and perform RRC connection establishment with the UE.

In one embodiment, the processor 1105 is configured to cause the apparatus 1100 to transmit the second indication using broadcast signaling, a paging message, or a combination thereof.

In one embodiment, in response to broadcast signaling being used, the processor 1105 is configured to cause the apparatus 1100 to set a flag in a system information block to indicate the second indication.

In one embodiment, the UE device is in one of an RRC idle state or an RRC inactive state.

In one embodiment, in response to the UE device being in an RRC inactive state, the processor 1105 is configured to cause the apparatus 1100 to transmit the first indication in an RRC message, the RRC message comprising one of an RRCRelease message and a response to an RRCResumeRequest message.

In one embodiment, determining whether voice service is supported on the first cell or the at least one second cell is based on an availability of IP multimedia subsystem support.

In one embodiment, determining whether voice service is supported on the at least one second cell is based on network configuration information available from an operations, administration, and maintenance entity.

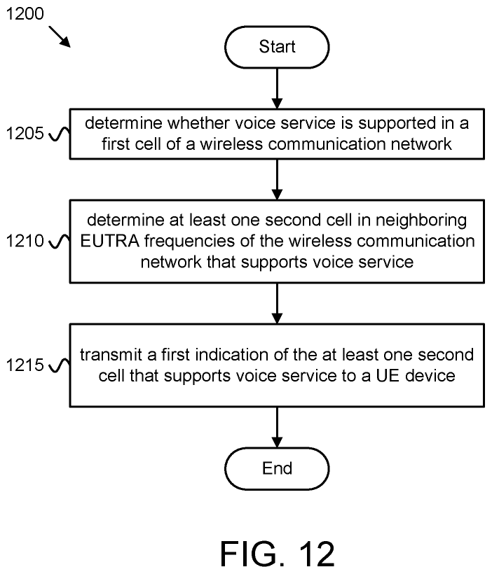

FIG. 12 is a flowchart diagram of a method 1200 for voice call support in wireless communication systems. The method 1200 may be performed by a UE as described herein, for example, the remote unit 105, the UE 205 and/or the user equipment apparatus 1000. In some embodiments, the method 1200 may be performed by a processor executing program code, for example, a microcontroller, a microprocessor, a CPU, a GPU, an auxiliary processing unit, a FPGA, or the like.

In one embodiment, the method 1200 begins and determines 1205 whether voice service is supported in a first cell of a wireless communication network. In one embodiment, the method 1200, in response to determining 1205 the first cell does not support voice service, determines 1210 at least one second cell in neighboring EUTRA frequencies of the wireless communication network that supports voice service. In one embodiment, the method 1200 transmits 1215 a first indication of the at least one second cell that supports voice service to a UE device, and the method 1200 ends.

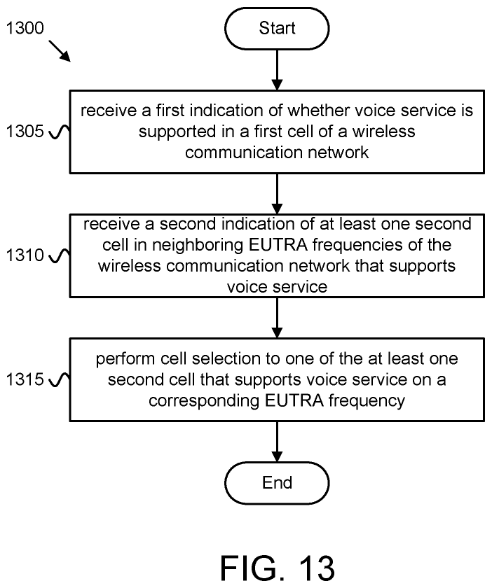

FIG. 13 is a flowchart diagram of a method 1300 for voice call support in wireless communication systems. The method 1300 may be performed by a network entity as described herein, for example, a base unit 121, a gNB, a network function, and/or the network equipment apparatus 1100. In some embodiments, the method 1300 may be performed by a processor executing program code, for example, a microcontroller, a microprocessor, a CPU, a GPU, an auxiliary processing unit, a FPGA, or the like.

In one embodiment, the method 1300 begins and receives 1305 a first indication of whether voice service is supported in a first cell of a wireless communication network. In one embodiment, the method 1300, in response to the first indication indicating that the first cell does not support voice service, receives 1310 a second indication of at least one second cell in neighboring EUTRA frequencies of the wireless communication network that supports voice service. In one embodiment, the method 1300 performs 1315 cell selection to one of the at least one second cell that supports voice service on a corresponding EUTRA frequency, and the method 1300 ends.

A first apparatus is disclosed for voice call support in wireless communication systems. The first apparatus may include a UE as described herein, for example, the remote unit 105, the UE 205 and/or the user equipment apparatus 1000. In some embodiments, the first apparatus includes a processor executing program code, for example, a microcontroller, a microprocessor, a CPU, a GPU, an auxiliary processing unit, a FPGA, or the like.

In one embodiment, the first apparatus includes a memory and a processor. In one embodiment, the processor is configured to cause the apparatus to determine whether voice service is supported in a first cell of a wireless communication network. In one embodiment, the processor is configured to cause the apparatus to, in response to determining the first cell does not support voice service, determine at least one second cell in neighboring EUTRA frequencies of the wireless communication network that supports voice service. In one embodiment, the processor is configured to cause the apparatus to transmit a first indication of the at least one second cell that supports voice service to a UE device.

In one embodiment, the processor is configured to cause the apparatus to, in response to determining the first cell supports voice service, transmit a second indication that the first cell supports voice service and perform RRC connection establishment with the UE.

In one embodiment, the processor is configured to cause the apparatus to transmit the second indication using broadcast signaling, a paging message, or a combination thereof.

In one embodiment, in response to broadcast signaling being used, the processor is configured to cause the apparatus to set a flag in a system information block to indicate the second indication.

In one embodiment, the UE device is in one of an RRC idle state or an RRC inactive state.

In one embodiment, in response to the UE device being in an RRC inactive state, the processor is configured to cause the apparatus to transmit the first indication in an RRC message, the RRC message comprising one of an RRCRelease message and a response to an RRCResumeRequest message.

In one embodiment, determining whether voice service is supported on the first cell or the at least one second cell is based on an availability of IP multimedia subsystem support.

In one embodiment, determining whether voice service is supported on the at least one second cell is based on network configuration information available from an operations, administration, and maintenance entity.

A first method is disclosed for voice call support in wireless communication systems. The first method may be performed by a UE as described herein, for example, the remote unit 105, the UE 205 and/or the user equipment apparatus 1000. In some embodiments, the first method may be performed by a processor executing program code, for example, a microcontroller, a microprocessor, a CPU, a GPU, an auxiliary processing unit, a FPGA, or the like.

In one embodiment, the first method determines whether voice service is supported in a first cell of a wireless communication network. In one embodiment, the first method, in response to determining the first cell does not support voice service, determines at least one second cell in neighboring EUTRA frequencies of the wireless communication network that supports voice service. In one embodiment, the first method transmits a first indication of the at least one second cell that supports voice service to a UE device.

In one embodiment, the first method, in response to determining the first cell supports voice service, transmits a second indication that the first cell supports voice service and perform RRC connection establishment with the UE.

In one embodiment, the first method transmits the second indication using broadcast signaling, a paging message, or a combination thereof.

In one embodiment, in response to broadcast signaling being used, the first method sets a flag in a system information block to indicate the second indication.

In one embodiment, the UE device is in one of an RRC idle state or an RRC inactive state.

In one embodiment, in response to the UE device being in an RRC inactive state, the first method transmits the first indication in an RRC message, the RRC message comprising one of an RRCRelease message and a response to an RRCResumeRequest message.

In one embodiment, determining whether voice service is supported on the first cell or the at least one second cell is based on an availability of IP multimedia subsystem support.

In one embodiment, determining whether voice service is supported on the at least one second cell is based on network configuration information available from an operations, administration, and maintenance entity.

A second apparatus is disclosed for voice call support in wireless communications system. The second apparatus may include a UE as described herein, for example, the remote unit 105, the UE 205 and/or the user equipment apparatus 1000. In some embodiments, the second apparatus includes a processor executing program code, for example, a microcontroller, a microprocessor, a CPU, a GPU, an auxiliary processing unit, a FPGA, or the like.

In one embodiment, the second apparatus includes a memory and a processor. In one embodiment, the processor is configured to cause the apparatus to receive a first indication of whether voice service is supported in a first cell of a wireless communication network. In one embodiment, the processor is configured to cause the apparatus to, in response to the first indication indicating that the first cell does not support voice service, receive a second indication of at least one second cell in neighboring EUTRA frequencies of the wireless communication network that supports voice service. In one embodiment, the processor is configured to cause the apparatus to perform cell selection to one of the at least one second cell that supports voice service on a corresponding EUTRA frequency.

In one embodiment, in response to the first indication indicating that the first cell supports voice service, the processor is configured to cause the apparatus to initiate RRC connection establishment on the first cell.

In one embodiment, in response to the second indication indicating that all second cells in neighboring EUTRA frequencies support voice service, the processor is configured to cause the apparatus to perform cell selection for the UE on any neighboring EUTRA frequency provided in a system information block.

In one embodiment, in response to the second indication indicating that a subset of all second cells in neighboring EUTRA frequencies support voice service, the processor is configured to cause the apparatus to perform cell selection for the UE on at least one of the subset of neighboring EUTRA frequencies provided in a system information block, the subset listed by EUTRA frequency in the system information block.

In one embodiment, in response to the second indication indicating that none of the second cells in neighboring EUTRA frequencies support voice service, the processor is configured to cause the apparatus to perform circuit switched fallback.

In one embodiment, the processor is configured to cause the apparatus to receive the first or second indications using broadcast signaling, a paging message, or a combination thereof.

A second method is disclosed for voice call support in wireless communication systems. The second method may be performed by a UE as described herein, for example, the remote unit 105, the UE 205 and/or the user equipment apparatus 1000. In some embodiments, the second method may be performed by a processor executing program code, for example, a microcontroller, a microprocessor, a CPU, a GPU, an auxiliary processing unit, a FPGA, or the like.

In one embodiment, the second method receives a first indication of whether voice service is supported in a first cell of a wireless communication network. In one embodiment, the second method, in response to the first indication indicating that the first cell does not support voice service, receives a second indication of at least one second cell in neighboring EUTRA frequencies of the wireless communication network that supports voice service. In one embodiment, the second method performs cell selection to one of the at least one second cell that supports voice service on a corresponding EUTRA frequency.

In one embodiment, in response to the first indication indicating that the first cell supports voice service, the second method initiates RRC connection establishment on the first cell.

In one embodiment, in response to the second indication indicating that all second cells in neighboring EUTRA frequencies support voice service, the second method performs cell selection for the UE on any neighboring EUTRA frequency provided in a system information block.

In one embodiment, in response to the second indication indicating that a subset of all second cells in neighboring EUTRA frequencies support voice service, the second method performs cell selection for the UE on at least one of the subset of neighboring EUTRA frequencies provided in a system information block, the subset listed by EUTRA frequency in the system information block.

In one embodiment, in response to the second indication indicating that none of the second cells in neighboring EUTRA frequencies support voice service, the second method performs circuit switched fallback.

In one embodiment, the second method receives the first or second indications using broadcast signaling, a paging message, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network entity (NE) for wireless communication, comprising:
at least one memory; and
at least one processor coupled with the at least one memory and configured to cause the NE to:
determine whether voice service is supported in a first cell of a wireless communication network;
in response to determining the first cell does not support voice service, determine at least one second cell in neighboring evolved universal terrestrial radio access (“EUTRA”) frequencies of the wireless communication network that supports voice service; and
transmit a first indication of the at least one second cell that supports voice service to a user equipment (“UE”).

2. The NE of claim 1, wherein;
the at least one processor is configured to cause the NE to, in response to determining the first cell supports voice service, transmit a second indication that the first cell supports voice service and perform radio resource control (“RRC”) connection establishment with the UE.

3. The NE of claim 2, wherein:
the at least one processor is configured to cause the NE to transmit the second indication using broadcast signaling, a paging message, or a combination thereof.

4. The NE of claim 3, wherein, in response to broadcast signaling being used:
the at least one processor is configured to cause the NE to set a flag in a system information block to indicate the second indication.

5. The NE of claim 1, wherein:
the UE is in one of a radio resource control (“RRC”) idle state or an RRC inactive state.

6. The NE of claim 5, wherein, in response to the UE being in an RRC inactive state:
the at least one processor is configured to cause the NE to transmit the first indication in an RRC message, the RRC message comprising one of an RRCRelease message and a response to an RRCResumeRequest message.

7. The NE of claim 1, wherein:
determining whether voice service is supported on the first cell or the at least one second cell is based on an availability of internet protocol (“IP”) multimedia subsystem support.

8. The NE of claim 1, wherein:
determining whether voice service is supported on the at least one second cell is based on network configuration information available from an operations, administration, and maintenance entity.

9. A user equipment (UE) for wireless communication, comprising:
at least one memory; and
at least one processor coupled with the at least one memory and configured to cause the UE to:
receive a first indication of whether voice service is supported in a first cell of a wireless communication network;
in response to the first indication indicating that the first cell does not support voice service, receive a second indication of at least one second cell in neighboring evolved universal terrestrial radio access (“EUTRA”) frequencies of the wireless communication network that supports voice service; and
perform cell selection to one of the at least one second cell that supports voice service on a corresponding EUTRA frequency.

10. The UE of claim 9, wherein, in response to the first indication indicating that the first cell supports voice service:
the at least one processor is configured to cause the UE to initiate radio resource control (“RRC”) connection establishment on the first cell.

11. The UE of claim 9, wherein, in response to the second indication indicating that all second cells in neighboring EUTRA frequencies support voice service:
the at least one processor is configured to cause the UE to perform cell selection on a neighboring EUTRA frequency provided in a system information block.

12. The UE of claim 9, wherein, in response to the second indication indicating that a subset of all second cells in neighboring EUTRA frequencies support voice service:
the at least one processor is configured to cause the UE to perform cell selection on at least one of the subset of neighboring EUTRA frequencies provided in a system information block, the subset listed by EUTRA frequency in the system information block.

13. The UE of claim 9, wherein, in response to the second indication indicating that none of the second cells in neighboring EUTRA frequencies support voice service:
the at least one processor is configured to cause the UE to perform circuit switched fallback.

14. The UE of claim 9, wherein:
the at least one processor is configured to cause the UE to receive the first or second indications using broadcast signaling, a paging message, or a combination thereof.

15. A method, comprising:
determining whether voice service is supported in a first cell of a wireless communication network;
in response to determining the first cell does not support voice service, determining at least one second cell in neighboring evolved universal terrestrial radio access (“EUTRA”) frequencies of the wireless communication network that supports voice service; and
transmitting a first indication of the at least one second cell that supports voice service to a user equipment (“UE”).

16. A processor for wireless communication, comprising:
at least one controller coupled with at least one memory and configured to cause the processor to:
determine whether voice service is supported in a first cell of a wireless communication network;
in response to determining the first cell does not support voice service, determine at least one second cell in neighboring evolved universal terrestrial radio access (“EUTRA”) frequencies of the wireless communication network that supports voice service; and
transmit a first indication of the at least one second cell that supports voice service to a user equipment (“UE”).

17. The processor of claim 16, wherein:
the at least one controller is configured to cause the processor to, in response to determining the first cell supports voice service, transmit a second indication that the first cell supports voice service and perform radio resource control (“RRC”) connection establishment with the UE.

18. The processor of claim 17, wherein:
the at least one controller is configured to cause the processor to transmit the second indication using broadcast signaling, a paging message, or a combination thereof.

19. The processor of claim 18, wherein:
the at least one controller is configured to cause the processor to set a flag in a system information block to indicate the second indication.

20. The processor of claim 16, wherein:
the UE is in one of a radio resource control (“RRC”) idle state or an RRC inactive state.
